(19) United States
(12) Patent Application Publication
(10) Pub. No.: US 2008/0226251 A1
(43) Pub. Date: Sep. 18, 2008

(54) Apparatus for Optical Fibre Installation by Fluid Drag

(75) Inventors: Rosamund Carol Neat, Hertfordshire (GB); John Kerry, Ipswich (GB); Matthew John Kerry, Ipswich (GB); Jeremy Norman Hardie-Clay, Chester (GB); Ian Rodney Torr, Flintshire (GB)

Correspondence Address: WHYTE HIRSCHBOECK DUDEK S C, 555 EAST WELLS STREET, SUITE 1900, MILWAUKEE, WI, 53202, US

(73) Assignee: AISIN AE CO., LTD., ANJO-SHI, AICHI-EKN (JP)

(21) Appl. No.: 11/817,850

(22) PCT Filed: Mar. 6, 2006
(86) PCT No.: PCT/GB06/00775

§ 371 Date: Feb. 19, 2008

(30) Foreign Application Priority Data
Mar. 8, 2005 (GB) 0504760.0

(51) Int. Cl. G02B 6/00

(52) U.S. Cl. 385/135; 385/134

(57) ABSTRACT

An apparatus for installing, by the blown fibre technique, at least one optical fibre or optical fibre unit (5) into a tube or tubular passageway (6), comprising a length of optical fibre/optical fibre unit on a reel or cartridge (8) which is contained within a pressure vessel (2), the length of optical fibre/optical fibre unit being preterminated at its inside tail by a connector (32).

This invention relates to optical fibres, and specifically to installation of optical fibres.

Optical fibres are used in the communications industry for transmitting information by light through the individual fibres. The optical fibres are normally contained within a cable of tubes, and may be installed after installation of the cable. One such method of installation of optical fibres is by the blown fibre technique, as described in EP0408266A2 (BICC & Corning) and EP0345043 (British Telecommunications), in which optical fibres are blown along lengths of tube by a flow of air created by a pressure vessel (which can be known as a blowing head), combined with a compressor or air/gas cylinder. For this purpose, one or more optical fibres may be packaged into a single fibre unit, e.g. a microduct fibre unit. Such units comprise an outer sheath surrounding one or more optical fibres, the sheath being disposed so as to facilitate its being blown along the tube.

It is known from GB2212942 (BICC & Corning) to provide a length of fibre unit ready for installation on a reel contained within a pressure vessel.

Currently, as optical fibre is blown along a tube, a length counter provided in the blowing head displays the length of fibre blown. An excess length must be blown along the tube, to allow for termination or splicing of the optical fibre at the end of the blowing route, for example to a further length of optical fibre, or to a terminal device. An excess length must also be left at the ‘inside tail’ of the optical fibre, i.e. the last section of optical fibre held on the reel or in a pan, to allow for splicing or termination. This results in relatively high cost of installation due to the significant termination activities at both ends of the blowing route.

Accordingly the present invention provides an apparatus for introducing at least one optical fibre into a tubular passageway, comprising a pressure vessel, a length of optical fibre having an inside tail, the optical fibre being provided on a reel disposed within the pressure vessel, and a connector provided on the inside tail of the length of optical fibre.

The optical fibres may be packaged into a unit of one or more optical fibres, such as a microduct fibre unit.

The invention provides a means of supporting a length of optical fibre (which may be packaged into a unit) on a reel and allowing the inside tail of the optical fibre to be terminated with a connector. The reel is designed to allow the connector to be removed from the reel once the optical fibre has been unwound. The reel is contained within a pressure vessel suitable for blown fibre application.

A storage device for slack fibre is also incorporated into the pressure vessel, the storage device acting as a capstan during the blowing process. It also acts as a fibre storage cassette when the installation is complete and can be fitted into a suitable wall box, rack or cabinet. The need for manual handling of the fibre is also minimised.

An advantage of the present invention is that a connector is provided at the end of the length of optical fibre to minimise the fibre handling, requirement for specialist fibre joining apparatus (splicing machine) and possible Health and Safety issues at this point in a network. It is particularly important that the possibility of short lengths of fibre, such as those sometimes produced as a function of preparing fibre for splicing, are not left in the home or office environment.

A further advantage is that as the preterminated optical fibre is supplied in specified lengths, the exact full length can be blown, thus minimising the amount of fibre that is required to be stored. This has the added advantage that a length counter does not have to be provided in the blowing head, therefore reducing complexity of the system.

A further advantage of the present invention is the increased ease of installation, which allows a reduction in manpower and costs as splicing or termination is minimised, i.e. splicing is only required once for each installation, at the furthest end of the blowing route, rather than at each end.

A further advantage of the present invention is that provision of the slack fibre storage cassette minimises handling of the optical fibre on installation.

A further advantage of the present invention is that the blowing unit can be battery powered.

Reference will now be made to embodiments of the invention by way of example to the accompanying drawings.

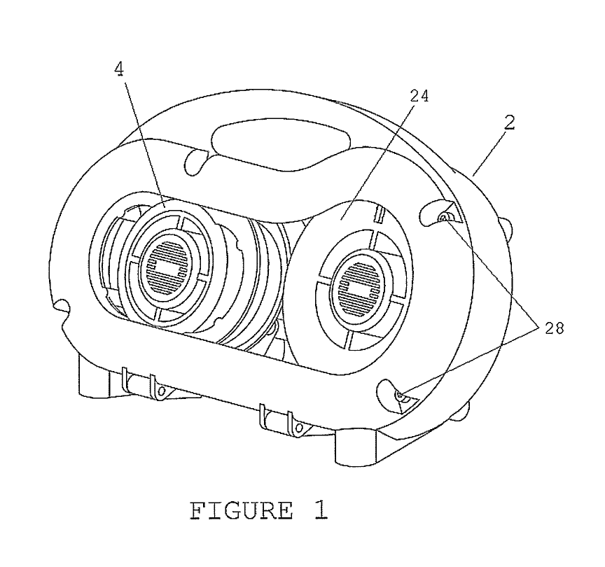

FIG. 1 is a perspective view of a blowing unit in accordance with the present invention.

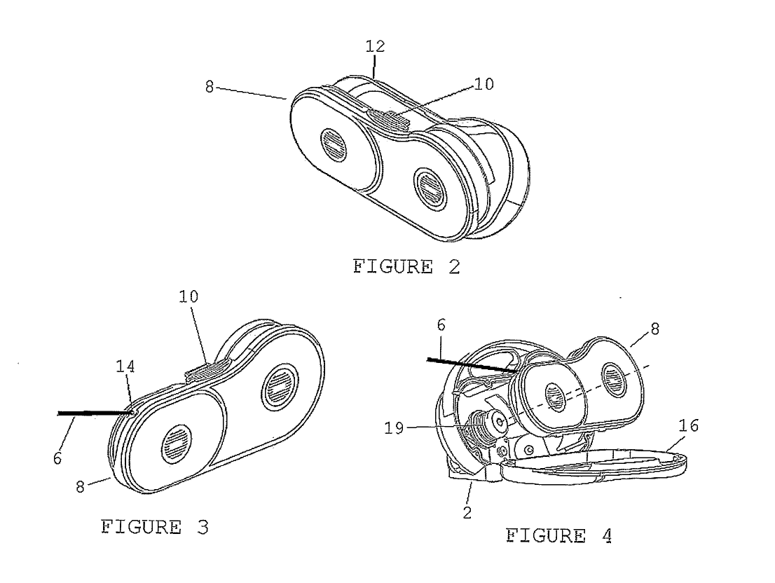

FIGS. 2 and 3 are perspective views of a fibre cartridge in accordance with the present invention.

FIGS. 4, 5 and 6 is a perspective view of a blowing unit and fibre cartridge in accordance with the present invention.

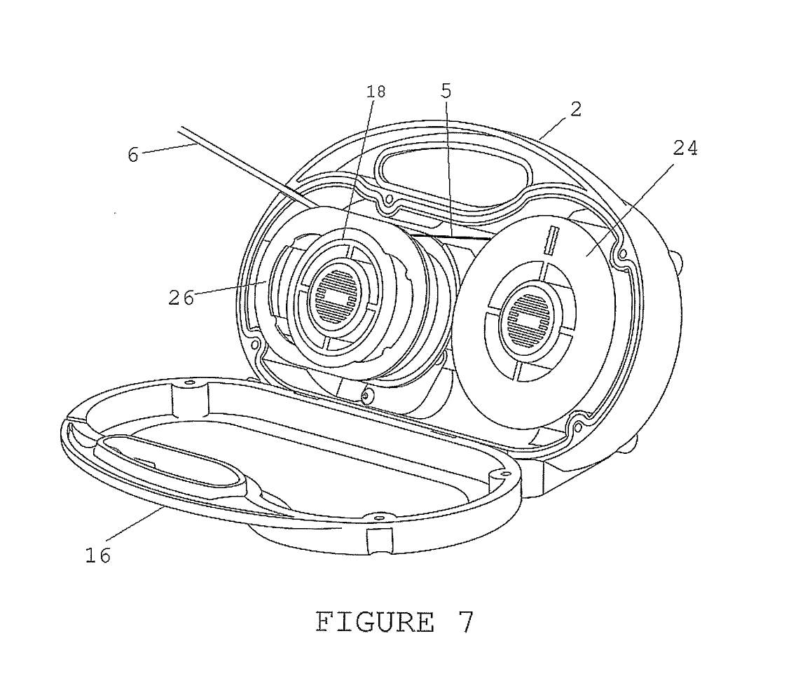

FIG. 7 is a perspective view of a blowing unit and in accordance with the present invention.

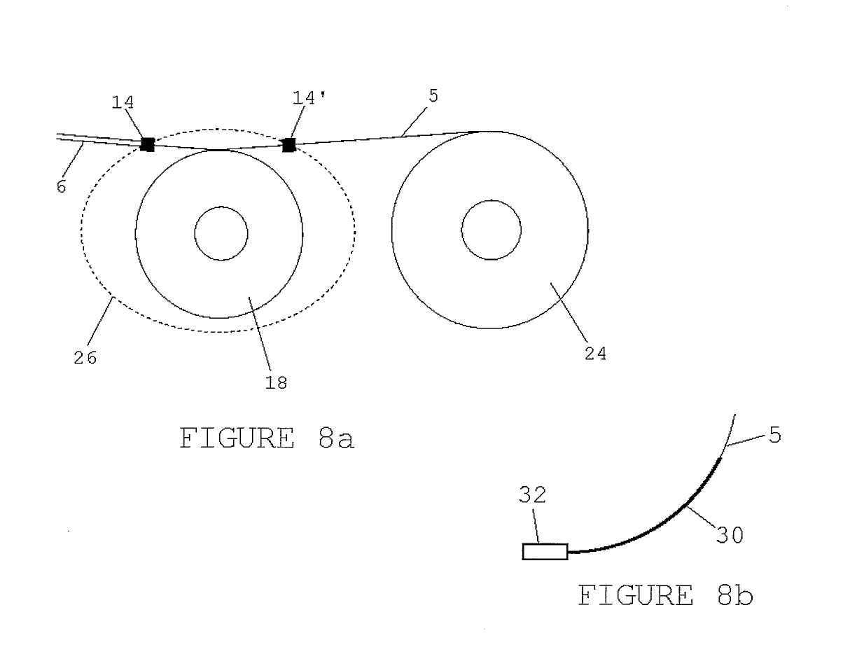

FIG. 8a is a schematic representation of a fibre reel, storage cassette and capstan in accordance with the present invention.

FIG. 8b is a schematic representation of the inside tail of a length of microduct fibre unit in accordance with the present invention.

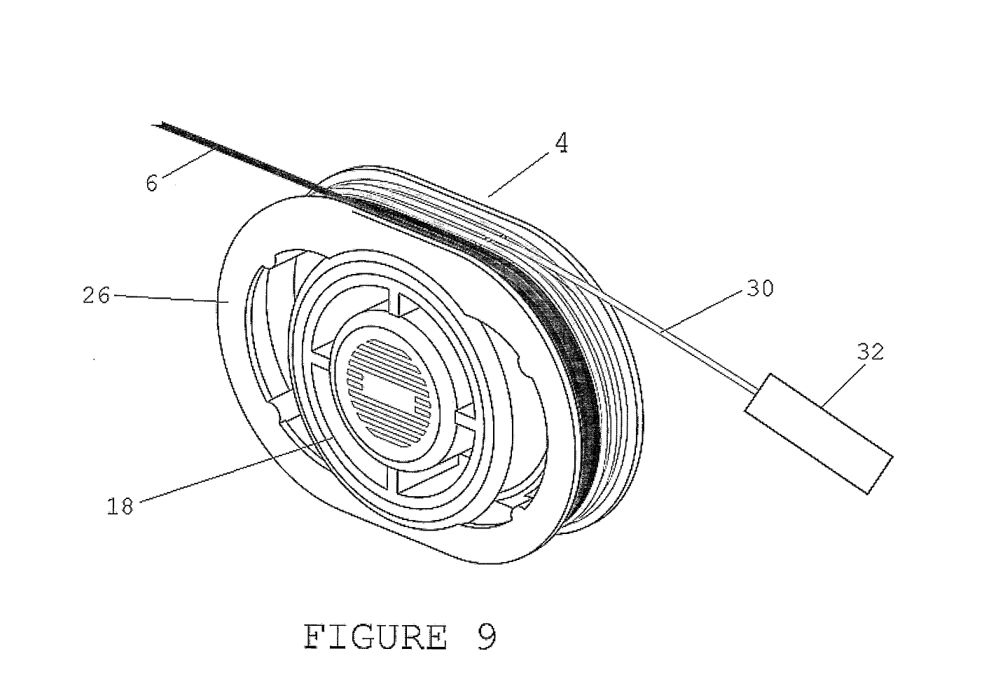

FIG. 9 is a perspective view of a storage cassette in accordance with the present invention.

As illustrated in FIG. 1, the present invention comprises a lightweight aluminium blowing unit 2 used as a pressure vessel, blowing unit 2 containing plastic storage cassette 4. Preterminated microduct fibre unit 5 (shown in FIGS. 8a and 8b) is supplied in fibre reel 24, and storage cassette 4.

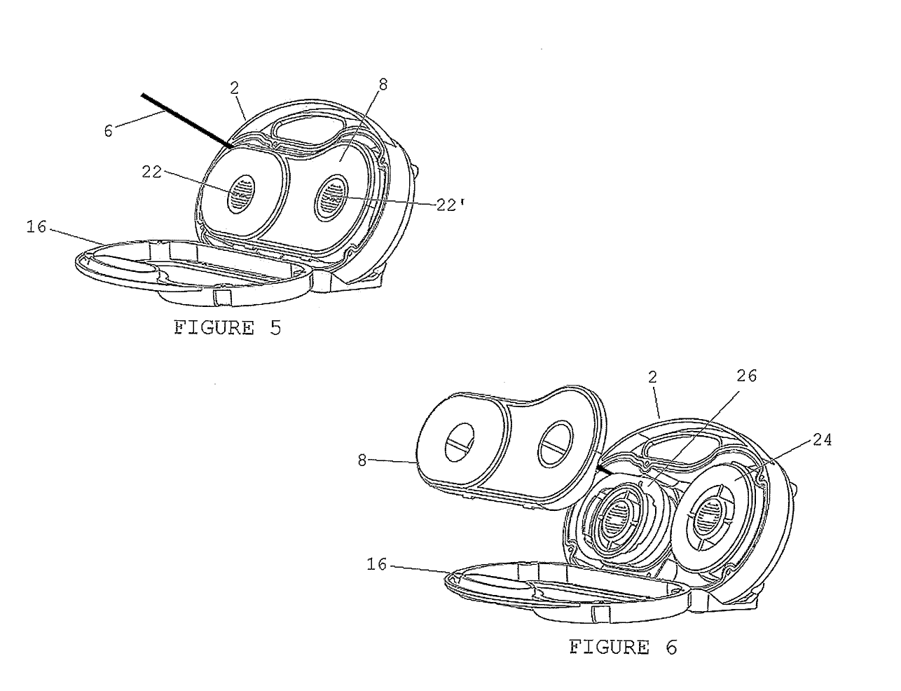

Prior to installation by blowing, microduct fibre unit 5 is introduced into blowing unit 2 from fibre cartridge 8. As illustrated in FIG. 2, release catch 10 on fibre cartridge 8 is pressed to allow cartridge back cover 12 to be removed. The free end of microduct fibre unit 5 is threaded into the start of the tube route 6. Tube 6, as illustrated in FIG. 3 (into which the microduct fibre unit is to be installed), is inserted into securing collet 14 provided in storage cassette 4, as illustrated in FIG. 8a. As shown in FIGS. 4 and 5, front cover 16 of blowing unit 2 is opened, and fibre cartridge 8 is placed onto capstan interface 19 and reel interface 20 (shown on FIG. 8a) of blowing unit 2. Release points 22 and 22′ on fibre cartridge 8 are pressed manually to release fibre reel 24 and outer cassette part 26 from the casing of fibre cartridge 8, as shown in FIG. 6. The casing of fibre cartridge 8 is then removed.

FIG. 7 shows the preparation of the system for installation of microduct fibre unit into a tube. The microduct fibre unit 5 from fibre reel 24 is wound at least once around capstan 18 as supplied and as illustrated diagrammatically in FIG. 8a. Front cover 16 of blowing unit 2 is closed and screws 28 (illustrated in FIG. 1) are tightened to make the pressure seal secure. The system is pressurised by use of a compressor or air/gas cylinder (not shown). Microduct fibre unit 5 is installed until ruggedised portion 30 (i.e. a portion of microduct fibre unit of a greater diameter than the remainder of microduct fibre unit 5, as shown diagrammatically in FIG. 8b) provided at the inside tail stops against second collet 14′ (shown in FIG. 8a) provided on storage cassette 4. FIG. 8a shows fibre passing from fibre reel 24, through collet 14′, around capstan 18 at least once, through securing collet 14 and into tube 6.

The pressure is released from the system, and front cover 16 of blowing unit 2 is opened. Ruggedised portion 30 is firmly located into second collet 14′. Preterminated connector 32 provided on the inside tail of microduct fibre unit 5 (as shown diagrammatically in FIG. 8b), is removed from fibre reel 24. Storage cassette 4 is removed from blowing unit 2 and front cover 16 closed. As shown in FIG. 9, storage cassette 4 comprises capstan 18 and outer cassette part 26. Storage cassette 4 can then be mounted in an outlet or termination box, rack or cabinet (not shown). Excess tube and/or excess ruggedised microduct fibre unit is wound around the outside of storage cassette 4, as shown in FIG. 9.

Preterminated connector 32 can subsequently be plugged in as required, e.g. into an opto-electronics module or uniter/coupler.

Blowing unit 2 could be formed of an alternative lightweight metal, or a suitable plastics material.

Parts of fibre cartridge 8, storage cassette 4 and/or blowing unit 2 may be manufactured from a clear plastics material to provide clearer visibility.

The fibre cartridge system is user-friendly, enabling fast and easy replacement, and minimising handling of the microduct fibre unit.

After installation of the microduct fibre unit, the fibre cartridge 8 and fibre reel 24 may be reused for subsequent installations.

1. An apparatus for introducing at least one optical fibre formed as a unit into a tubular passageway, comprising: a pressure vessel, characterized in that a cartridge is removeably fitted in the vessel, and a reel is fitted in the cartridge onto which reel the unit is wound, the unit having a tail at an end and a connector on the tail, wherein a stop arrangement is provided within the pressure vessel, wherein the tail of a greater diameter than the remainder of the unit, and whereby the tail is arranged to stop against the stop arrangement.

2. The apparatus as claimed in claim 1, wherein means are provided in the vessel to hold a slack portion of the length of optical fibre(s).

3. The apparatus as claimed in claim 2 wherein the means to hold a slack portion of the length of optical fibre(s) comprises a capstan which forms part of a storage cassette which is removable from the pressure vessel.

4. The apparatus as claimed in claim 3, wherein the reel and capstan are provided in the removable cartridge.

5. The apparatus as claimed in claim 4, wherein the cartridge has a removable casing.

6. The apparatus as claimed in claim 5, wherein at least one part of the apparatus is formed at least partially of a plastics material, the plastics material being at least partially transparent.

7. The apparatus as claimed in claim 5, wherein a portion of the inside tail of the length of optical fibre(s) is provided with a ruggedised covering such that the diameter of the portion of length of optical fibre(s) with the ruggedised covering is greater than the internal diameter of a collet provided in the pressure vessel.

8. An apparatus for introducing at least one optical fibre formed as a unit into a tubular passageway, comprising: a pressure vessel, characterized in that a cartridge is removeably fitted in the vessel, and a reel is fitted in the cartridge onto which reel the unit is wound, the unit having a tail at an end and a connector on the tail, wherein a stop arrangement is provided within the pressure vessel, and wherein a portion of the inside tail of the length of optical fibre(s) is provided with a ruggedised covering such that the diameter of the portion of length of optical fibre(s) with the ruggedised covering is greater than the internal diameter of a collet provided in the pressure vessel.

9. The apparatus as claimed in claim 8, wherein means are provided in the vessel to hold a slack portion of the length of optical fibre(s).

10. The apparatus as claimed in claim 9, wherein the means to hold a slack portion of the length of optical fibre(s) comprises a capstan which forms part of a storage cassette which is removable from the pressure vessel.

11. The apparatus as claimed in claim 10, wherein the reel and capstan are provided in the removable cartridge.

12. The apparatus as claimed in claim 11, wherein the cartridge has a removable casing.

13. The apparatus as claimed in claim 8, wherein the tail is of a greater diameter than the remainder of the unit, and whereby the tail is arranged to stop against the stop arrangement.
